(19) United States
(12) Patent Application Publication
(10) Pub. No.: US 2016/0264302 A1
(43) Pub. Date: Sep. 15, 2016

(54) CO-EXTRUDED PLASTIC FILM FOR USE WITH AN AUTOCLAVE

(71) Applicant: Petoskey Plastics, Inc., Petoskey, MI (US)

(72) Inventors: David James Blankenhagen, Petoskey, MI (US); Michael Neff Tramontini, Harbor Springs, MI (US)

(21) Appl. No.: 15/067,386

(22) Filed: Mar. 11, 2016

Related U.S. Application Data
(60) Provisional application No. 62/132,089, filed on Mar. 12, 2015.

(51) Int. Cl. B65D 30/08; B32B 27/20; B32B 27/32; B32B 27/08

(52) U.S. Cl. CPC B65D 31/02; B32B 27/08; B32B 27/20; B32B 27/32; B32B 2439/06

(57) ABSTRACT

A co-extruded plastic film for use in a refuse-containing bag that is used in an autoclaving process. The plastic film has three layers that are co-extruded together, and the plastic film includes an inner layer, a middle layer, and an outer layer. The inner and outer layers include a thermoplastic polyolefin and a quantity of polypropylene, and the thermoplastic polyolefin comprises at least 40% by weight of the inner layer, and the polypropylene comprises less than 50% by weight of the inner and outer layers. The middle layer has at least 50% by weight of a thermoplastic polyolefin, and at least 7% by weight of a filler. Polypropylene comprises less than 50% by weight of the plastic film, and the film is capable of withstanding an autoclaving process in which the environmental temperatures reach 250° F. for twenty minutes or longer.

### CROSS REFERENCE TO RELATED APPLICATION

This application claims the benefit of U.S. Provisional Application 62/132,089, which was filed on Mar. 12, 2015, the disclosure of which is hereby incorporated by reference.

The present invention pertains to a multi-layered polymer film. More particularly, the present invention pertains to a co-extruded multi-layered polymer film that can withstand an autoclave process.

### DESCRIPTION OF THE PRIOR ART

Steam sterilization, or autoclaving, is used in various applications for the disinfection and sterilization of waste prior to disposal. A typical autoclave process will reach temperatures up to 250° F. to 260° F. for up to twenty minutes or more. One such application where waste is sterilized by an autoclave is for trash from international flights in order to stop the spread of disease being carried by travelers.

Another important application is for sterilizing medical waste before it is disposed. The medical waste is collected in medical waste bags, which are typically colored red. The medical waste bags are then placed on a cart or in a bin, and the entire cart or bin is wheeled into the autoclave machine. A greater degree of care is often used with sterilizing medical waste to ensure that complete sterilization takes place. Therefore an autoclave process for medical waste can reach elevated temperatures up to 280° F. or 290° F. for up to twenty minutes or more to make sure all of the contents are sterilized.

The medical waste bags are not designed to maintain their structural integrity through the autoclave process. Thus, a plastic film liner is provided which separates the medical waste from the cart or bin. The liner must be capable of withstanding the steam sterilization process without degrading or melting.

Most of the autoclave liners in the prior art are mono-layer plastic films typically made with a majority percentage of polypropylene. Polypropylene can withstand the prolonged heat encountered during the autoclave process, unlike a mono-layer film made from typical plastic film materials like low density polyethylene (LDPE) or linear low density polyethylene (LLDPE). For example, most LLDPE resins begin to soften or melt around 225° F. As a result, for autoclave applications, plastic films for bag and cart liners are usually made from mono-layer polypropylene resins in order to meet the target temperature of 280° F. to 290° F. However, polypropylene is a relatively expensive material in comparison with other materials that would otherwise be suitable replacements, if not for the temperatures in the autoclave process.

Thus, there remains a need for a plastic film that can withstand the temperatures encountered during an autoclave process, yet which costs less than a mono-layer polypropylene-based film.

The present invention, as detailed hereinbelow, seeks to provide a plastic film which has multiple layers and includes less expensive materials that would not be suitable for use alone in a mono-layer autoclavable plastic film, but which are suitable when combined with other materials in the multi-layered plastic film.

### SUMMARY OF THE INVENTION

According to a preferred embodiment of the invention, there is provided a plastic film comprising:
(a) an inner layer having at least 40% by weight of a thermoplastic polyolefin, and a quantity of polypropylene, the polypropylene being less than 50% by weight of the inner layer;
(b) a middle layer having at least 50% by weight of a thermoplastic polyolefin, and at least 7% by weight of a filler; and
(c) an outer layer having at least 40% by weight of a thermoplastic polyolefin, and a quantity of polypropylene, the polypropylene being less than 50% by weight of the outer layer; and
(d) wherein polypropylene comprises less than 50% by weight of the plastic film.

Optionally, the middle layer comprises about 50%-90% by thickness of the plastic film. Preferably the middle layer comprises about 70% by thickness of the plastic film, and the inner and outer layers preferably each comprise about 15% by thickness of the plastic film.

Optionally, the inner and outer layers each include at least 1% by weight of an anti block agent, and the middle and inner layers each include at least 0.5% by weight of a slip agent.

Optionally, the thermoplastic polyolefin in each layer includes at least one additive selected from the group consisting of: a polypropylene having an ethylene content of 2%-90% by weight, a polyethylene plastomer, a plasticized thermoplastic elastomer, a plasticized polyvinyl chloride, an ethylene propylene diene monomer (EPDM) rubber, an ethylene-vinyl acetate copolymer polyethylene, an ethylene methacrylate copolymer polyethylene, a poly(styrene-butadiene-styrene) polymer, and a styrene-isoprene-styrene polymer.

Optionally, the filler is a mineral, or the filler may be selected from the group consisting of: natural silica (silicon dioxide), talc (magnesium silicate), synthetic silica (silicon dioxide), calcium carbonate, ceramic spheres (alumina-silicate ceramic), Kaolin (aluminum silicate), and mica (aluminum potassium silicate).

### DETAILED DESCRIPTION OF THE PREFERRED EMBODIMENT

As referenced herein, the terms “inner layer,” “middle layer,” and “outer layer” are intended to reference the layers of the plastic film in which the bottom-most layer which is positioned closest to the cart or bin is the inner layer, the outer layer is the layer on the upper side of the film that is positioned toward the medical waste bags, and the middle layer is the layer sandwiched between the inner and outer layers.

Furthermore, the percentages by weight of various polymers and components identified herein are directed to the percentage by weight of that particular layer, not the entire film.

According to a preferred embodiment of the invention, there is provided a plastic film comprising: (a) an inner layer comprising at least 40% by weight of a thermoplastic polyolefin, and less than 50% by weight of a polypropylene; (b) a middle layer comprising at least 50% by weight of a thermoplastic polyolefin, at least 15% by weight of a filler, and less than 50% by weight of a polypropylene; and (c) an outer layer comprising at least 40% by weight of a thermoplastic polyolefin, and less than 50% by weight of a polypropylene.

Preferably, the middle layer comprises about 50%-90% by thickness of the plastic film. Even more preferably, the middle layer comprises about 70% by thickness of the plastic film, and the inner and outer layers preferably each comprise about 15% by thickness of the plastic film.

As understood by those having ordinary skill in the art, a thermoplastic polyolefin is a polymer blend usually including polypropylene and/or polyethylene, as well as reinforcing filler. Preferably the thermoplastic polyolefin comprises at least 40% by weight of the inner layer, at least 50% by weight of the middle layer, and at least 40% by weight of the outer layer. The thermoplastic polyolefin preferably has a density of about 0.877 g/cm³ and a melt index of about 0.69 g/10 min (230° C./2.16 Kg).

The thermoplastic polyolefin includes at least one additive selected from the group consisting of: a polypropylene having an ethylene content of 2%-90% by weight, a polyethylene plastomer, a plasticized thermoplastic elastomer, a plasticized polyvinyl chloride, an ethylene propylene diene monomer (EPDM) rubber, an ethylene-vinyl acetate copolymer polyethylene, an ethylene methacrylate copolymer polyethylene, a poly(styrene-butadiene-styrene) polymer, and a styrene-isoprene-styrene polymer.

Each of the inner and outer layers includes a quantity of polypropylene, and the polypropylene comprises less than 50% by weight of each respective layer. Optionally, the middle layer can also include a quantity of polypropylene. When the middle layer includes polypropylene, the polypropylene comprises less than 50% by weight of the middle layer. As discussed above, it is an object of the invention to reduce the volume of polypropylene within the film in order to reduce cost.

The middle layer includes a filler which helps the plastic film withstand the heat from the autoclave process. The filler may be a mineral, such as natural silica (silicon dioxide), talc (magnesium silicate), calcium carbonate, Kaolin (aluminum silicate), or mica (aluminum potassium silicate). The filler may also be a synthetic compound like ceramic spheres (alumina-silicate ceramic) or synthetic silica (silicon dioxide). Preferably the filler is calcium carbonate (CaCO₃).

Preferably the filler comprises at least 7% by weight of the middle layer. Even more preferably, the filler comprises about 16% by weight of the middle layer. The filler is delivered by a carrier such as a LLDPE butene carrier resin having a melt index of 1.0 g/10 min and a density of 1.95 g/cm³. The filler and the LLDPE butene carrier resin are preferably provided in a ratio of about 80% filler and 20% LLDPE.

The inner and outer layers preferably include at least 1% by weight of an anti-blocking compound. More preferably, the inner layer comprises about 5% by weight of the anti-blocking compound, and the outer layer preferably comprises about 10% by weight of the anti-blocking compound.

The anti-blocking compound includes an anti block agent, which is well-known in the art for reducing or blocking the adhesion between two adjacent layers of film, such as two walls of a plastic bag. The anti block agent can be any suitable type of agent that is well-known in the art, including but not limited to, natural silica (silicon dioxide), talc (magnesium silicate), synthetic silica (silicon dioxide), calcium carbonate, ceramic spheres (alumina-silicate ceramic), Kaolin (aluminum silicate), or mica (aluminum potassium silicate). The anti-blocking compound preferably comprises about 60% talc and about 40% LLDPE butene carrier resin, and preferably has a melt index of 2.0 g/10 min and a density of 1.53 g/cm³.

Each of the middle and inner layers also includes at least 0.5% by weight of a slip agent. Slip agents are well-known to those having ordinary skill in the art, and they are provided to reduce the coefficient of friction along the surface of the plastic film. The slip agent may be either synthetic or natural, but it is of the type that is well-known in the art, such as a fatty amine. Preferably the slip agent comprises about 2% by weight of the middle and inner layers.

The multi-layered plastic film may be manufactured using any suitable type of process. In particular, the plastic film is preferably manufactured by blown-film co-extrusion using a circular die in which the film is blown to a specified size and thickness.

The plastic film may be used for any suitable type of pliable container, such as a liner for an autoclave cart or a waste bag.

The plastic film has been described hereinabove as being used as a liner for a cart or bin in an autoclave. As such, one embodiment of the present invention includes a liner for use in an autoclave cart comprising the plastic film described hereinabove including an open top, at least one flexible wall, and a closed bottom surface, whereby the wall and the closed bottom surface contain and encircle any contents placed therein.

However, the plastic film is also a suitable replacement material for use with the medical waste bags as well. In another embodiment of the present invention, there is provided a waste bag comprising the plastic film described hereinabove including an open top, at least one flexible wall, and a closed bottom, whereby the wall and the closed bottom contain and encircle any contents placed therein.

In this regard, the plastic film provides a superior product because, as discussed above, the medical waste bags in the prior art cannot structurally withstand the autoclave process, thus requiring the liner. When the plastic film is used for the medical waste bags, then the plastic film can be dyed as desired and can also include heat-activated inks which are well-known in the art. Such heat-activated inks become visible to the naked eye (or possibly change color) once the bag has undergone sterilization in an autoclave.

According to the invention described above, there is provided a plastic film that can withstand the temperatures encountered during an autoclave process, yet which costs less than a mono-layer polypropylene-based film due to the reduced material cost of the polypropylene.

What is claimed is:

1. A plastic film comprising:
(a) an inner layer including a thermoplastic polyolefin and a quantity of polypropylene, the thermoplastic polyolefin comprising at least 40% by weight of the inner layer, and the polypropylene comprising less than 50% by weight of the inner layer;
(b) a middle layer having at least 50% by weight of a thermoplastic polyolefin, and at least 7% by weight of a filler;
(c) an outer layer including a thermoplastic polyolefin and a quantity of polypropylene, the thermoplastic polyolefin comprising at least 40% by weight of the outer layer, and the polypropylene comprising less than 50% by weight of the outer layer; and
(d) wherein polypropylene comprises less than 50% by weight of the plastic film, and the plastic film is capable of withstanding an autoclaving process in which the environmental temperatures reach 250° F. for twenty minutes or longer.

2. The plastic film of claim 1 in which the middle layer comprises about 50%-90% by thickness of the plastic film.

3. The plastic film of claim 2 in which the middle layer comprises about 70% by thickness of the plastic film.

4. The plastic film of claim 3 in which the inner and outer layers each comprise about 15% by thickness of the plastic film.

5. The plastic film of claim 4 in which the filler is calcium carbonate.

6. The plastic film of claim 1 in which the filler is calcium carbonate.

7. The plastic film of claim 4 in which the filler is selected from the group consisting of: natural silica (silicon dioxide), talc (magnesium silicate), synthetic silica (silicon dioxide), calcium carbonate, ceramic spheres (alumina-silicate ceramic), Kaolin (aluminum silicate), and mica (aluminum potassium silicate).

8. The plastic film of claim 1 in which the filler is selected from the group consisting of: natural silica (silicon dioxide), talc (magnesium silicate), synthetic silica (silicon dioxide), calcium carbonate, ceramic spheres (alumina-silicate ceramic), Kaolin (aluminum silicate), and mica (aluminum potassium silicate).

9. A pliable container for use in an autoclave comprising:
(a) a plastic film forming a flexible wall and a closed bottom surface for containing refuse contents, the plastic film being capable of withstanding a temperature of 250°, and the plastic film having an inner layer, a middle layer, and an outer layer;
(b) the inner layer including a thermoplastic polyolefin and a quantity of polypropylene, the thermoplastic polyolefin comprising at least 40% by weight of the inner layer, and the polypropylene comprising less than 50% by weight of the inner layer;
(c) a middle layer having at least 50% by weight of a thermoplastic polyolefin, and at least 7% by weight of a filler;
(d) an outer layer including a thermoplastic polyolefin and a quantity of polypropylene, the thermoplastic polyolefin comprising at least 40% by weight of the outer layer, and the polypropylene comprising less than 50% by weight of the outer layer; and
(e) wherein polypropylene comprises less than 50% by weight of the plastic film, and the plastic film is capable of withstanding an autoclaving process in which the environmental temperatures reach 250° F. for twenty minutes or longer.

10. The pliable container of claim 9 in which the middle layer comprises about 50%-90% by thickness of the plastic film.

11. The pliable container of claim 10 in which the middle layer comprises about 70% by thickness of the plastic film.

12. The pliable container of claim 11 in which the inner and outer layers each comprise about 15% by thickness of the plastic film.

13. The pliable container of claim 12 in which the filler is calcium carbonate.

14. The pliable container of claim 9 in which the filler is calcium carbonate.

15. The pliable container of claim 12 in which the filler is selected from the group consisting of: natural silica (silicon dioxide), talc (magnesium silicate), synthetic silica (silicon dioxide), calcium carbonate, ceramic spheres (alumina-silicate ceramic), Kaolin (aluminum silicate), and mica (aluminum potassium silicate).

16. The pliable container of claim 9 in which the filler is selected from the group consisting of: natural silica (silicon dioxide), talc (magnesium silicate), synthetic silica (silicon dioxide), calcium carbonate, ceramic spheres (alumina-silicate ceramic), Kaolin (aluminum silicate), and mica (aluminum potassium silicate).

17. The plastic film of claim 1 in which the plastic film is manufactured by a blown-film co-extrusion.

18. The pliable container of claim 9 in which the plastic film is manufactured by a blown-film co-extrusion.
